(19) United States
(12) Patent Application Publication
(10) Pub. No.: US 2013/0201667 A1
(43) Pub. Date: Aug. 8, 2013

(54) AHM Coupling

(71) Applicant: Jeremy Todd Ratner, Villa Rica, GA (US)

(72) Inventor: Jeremy Todd Ratner, Villa Rica, GA (US)

(21) Appl. No.: 13/368,145

(22) Filed: Feb. 7, 2012

(51) Int. Cl. F21L 4/02

(52) U.S. Cl. 362/158

(57) ABSTRACT

An aluminum or aluminum-alloy coupling that fastens with two sets of screws securely to couplings of fire department attack hose lines and aides firefighters to a means of egress. The AHM coupling will house two sets of red and green Light-emitting diodes powered by Lithium-ion battery cells, attached to a water proof and fire retardant circuit board, which illuminates in smoke filled environments and assists in decreasing firefighter disorientation. Firefighters will follow the green light-emitting diode side of the coupling out of the burning structure to safety, while the red light-emitting diode side will warn the firefighters that they are headed towards the source of fire.

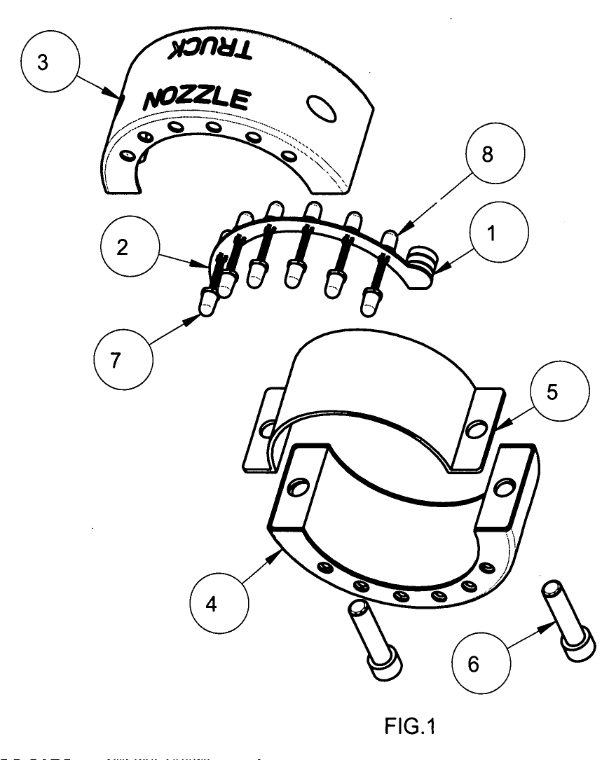

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### TECHNICAL FIELD AND INDUSTRIAL APPLICABILITY OF THE INVENTION

This invention relates to the manufacturing of the AHM Coupling. The present invention relates particularly to a coupling comprised of materials mostly that of aluminum alloy which houses red and green LED lights and will illuminate in extreme IDLH (Immediate Danger to Life and Health) conditions for firefighter safety.

### BACKGROUND OF THE INVENTION

Firefighter Disorientation, which is loss of direction due to the lack of vision in a structure fire, is one of firefighting's most serious hazards and according to the National Institute of Occupational Safety and Health (NIOSH), usually precedes firefighter fatality. In an effort to stop firefighter fatalities caused by smoke inhalation, burns, and traumatic injuries attributable to disorientation, a firefighter disorientation study was conducted.

The firefighter disorientation study focused on 17 incidents occurring between 1979 and 2001 in which disorientation played a major part in 23 firefighter fatalities. In addition to other data, including interviews with firefighters involved in the incidents, the study was facilitated by the detailed information provided by the Firefighter Fatality Investigation Reports of The National Institute for Occupational Safety and Health. The reports allowed for the study of specific incidents in which disorientation was known to have occurred.

During this investigation each incident was closely examined with special attention given to the information about the involved structures, the conditions found on and after arrival of the responding units, the strategy and tactics utilized and the actions that occurred in the structure. The structures firefighters responded to were of various sizes and material types, in 94% of the incidents the conditions upon arrival the structures on the exterior were clear of smoke, and in one case there was fire showing from the upper floor of an apartment fire. After arrival, firefighters were then exposed to heavy fire conditions as fire conditions increase to a level of possible rollovers, flashovers, and backdrafts due to structures designed with materials which support combustion. In 100% of the cases, firefighters initially executed an aggressive interior attack to locate and extinguish the seat of the fire. The study found that in 100% of the cases the firefighters became disoriented, exceeded their air supply and became either trapped in the structure or lost due to confusion.

Up till this point the answer has been how firefighters can eliminate the disorientation sequence. The answer has always been to establish standard operating procedures for strategies and tactics, building construction and train in live fire buildings which decreases the unfamiliarity of life threatening hazards during real life situations. The old thumb rule of following the hose line and attempting to differentiate the pattern of smooth surface followed by two surfaces of bumps can longer be our answer when lives are at stake whether is the firefighters or those they encounter during a rescue operation.

### DESCRIPTION OF THE RELATED ART

The AHM Coupling was invented by Firefighter Jeremy Ratner to decrease firefighter disorientation fatalities in smoke filled and extreme fire situations. The aluminum alloy coupling will house red and green LED lights which will be powered by Lithium Ion batteries in a waterproof/heat resistant casing. The AHM Coupling will connect to the outside of firefighter interior attack hose line couplings and illuminate to give direction to disoriented firefighters. As the firefighter becomes confused he/she will attempt to locate the nearest hose line and follow the green LED lights on the AHM Coupling as a means of egress. If the firefighter follows the red LED lights he/she will head in a direction towards the fire and know that they must head in the opposite direction.

### FIELD OF THE INVENTION

The invention pertains to an illuminated coupling. More specifically, a coupling that will illuminate and attach to a fire department hose coupling.

### BRIEF SUMMARY OF THE INVENTION

The AHM Coupling will save lives, assist responders during search and rescue operations and limit the possibility for firefighter disorientation cases in the world. The public will be made aware of possible risks and be made aware of an additional tool to help to public fire safety to children in school.

### BRIEF DESCRIPTION OF THE DRAWING

The drawings illustrate the components of the AHM Coupling.
1. 2-D Drawing

a. In bullet number one the illustration shows the lithium ion battery button cells

b. In bullet number two the illustration shows the circuit board

c. In bullet number three the illustrations shows the housing and the words “TRUCK and NOZZLE” referred to as the directional method as to which the firefighters will place the coupling on the hose couplings

d. In bullet number 4 the illustration shows the housing

e. In bullet number 5 the illustration shows the casing

f. In bullet number 6 the illustration shows the screws to which the AHM
Coupling will be applied to the fire department hose coupling.

g. In bullet numbers 8 and 7 the Illustration shows the red and green LED lights that will illuminate to show directional path of egress for the firefighters and trapped victims.

2. 3-D drawing

a. The 3-D model of the AHM Coupling illustrates how the AHM Coupling will be applied to the fire department hose coupling and illustrates how the LED lights illuminate with proper placement.

b. The illustration gives a 360 degree view of the AHM Coupling.

### DETAILED DESCRIPTION OF THE INVENTION

The AHM Coupling was designed with firefighter safety in mind. Being a career firefighter for over 14 years and working in a department that lost one of their own to firefighter disorientation I felt the need to help make a difference and create an invention for International awareness in the fight against uncontrollable rescuer fatalities. The concept of lighting a coupling which will give the responders a better chance at survival and egress in life threatening situations can be a key element in protecting our own. The design is simple, add to an already existing coupling a dual illuminating coupling that is controlled by rechargeable lithium ion batteries and all the firefighters and victims have to do is follow the green lights for a safe heaven to an area of the structure not consumed by fire or smoke filled conditions or to an exit out of the structure. The components of the coupling will be able to with stand heat and water; while the housing of the coupling comprised of aluminum/aluminum-alloy will be able to with stand heat, water, drops and most contact to falling objects.

1. An illuminated coupling for assisting disoriented firefighters and/or their victims in a means of egress, during fire fighter suppression activities and/or rescue, the coupling will be connected to the existing coupling of the fire department hose line, the coupling:
a). constructed of aluminum/aluminum alloy composite material;
b). consisting of dual red and green LED lights to show direction path of travel;
c). powered by Lithium Ion battery button cells and water intrusion circuit boards;
d). a water resistant battery compartment,
e). containing the words stamped on top and bottom of the coupling reading “Nozzle and Truck” to identify the egress direction
f). which will be comprised of materials that will repel high thermal elements.
